(19) United States
(12) Patent Application Publication
(10) Pub. No.: US 2026/0097442 A1
(43) Pub. Date: Apr. 9, 2026

(54) TABLE SAW WITH SLIDING TABLE AND FLOATING CARRIAGE

(71) Applicant: Robert Bosch GmbH, Stuttgart (DE)

(72) Inventors: Hannah M. Higgins, Batavia, IL (US); Andrew Frolov, Glenview, IL (US)

(21) Appl. No.: 18/909,633

(22) Filed: Oct. 8, 2024

(51) Int. Cl. B23D 47/04

(52) U.S. Cl. CPC B23D 47/045

(57) ABSTRACT

A table saw includes a base table, a sliding table, and a carriage. The base table includes a first and second guide rail. The sliding table is configured for movement relative to the base table. The sliding table includes a third guide rail and a fourth guide rail. The carriage includes a support frame and at least four rollers configured for rotation relative to the support frame about corresponding axes of rotation. A first roller and a second roller of the at least four rollers are configured to receive the first guide rail and the third guide rail, and a third roller and a fourth roller of the at least four rollers are configured to receive the second guide rail and the fourth guide rail. The axes of rotation are substantially parallel. The carriage is configured for movement relative to the base table and the sliding table.

### FIELD

This disclosure relates to the field of table saws, and, in particular, to supporting a sliding table of a table saw.

### BACKGROUND

Numerous power tools have been developed to facilitate forming a workpiece into a desired shape. One such power tool for forming a workpiece is a table saw. Craftsman typically use table saws to cross-cut and rip-cut workpieces, such as hardwood, wood products, construction lumber, and other materials. Table saws are available as portable or jobsite units and non-portable or stationary table saws.

Most table saws include a workpiece support surface and a cutting blade that extends through an opening in the workpiece support surface. The workpiece support surface is a generally flat surface on which a user positions the workpiece for cutting. The cutting blade, typically a circular sawblade, is configured for rotation by an electric motor that is positioned below the support surface. An upper portion of the blade extends above the support surface through the opening in the support surface and is configured to contact the workpiece. A riving knife is positioned behind the sawblade and moves through a kerf in the workpiece to prevent jamming of the workpiece during a cutting operation.

The workpiece support surface of some table saws is partially defined by a sliding table portion to the left of the sawblade. The sliding table portion is movable relative to the sawblade and is used to support a workpiece during a cutting process. That is, the sliding table and the workpiece are moved past the sawblade to make a cut in the workpiece. The sliding table should glide smoothly back and forth with relatively low effort. Moreover, there should be minimal side-to-side play in the sliding table to ensure that the sawblade makes an accurate cut.

Known systems for supporting the sliding table do not provide sufficient cutting capacity, as is desired by some users. The cutting capacity is a maximum width or length of a workpiece that can be supported by the sliding table and cut by the sawblade. The cutting capacity is based on a distance that the sliding table is movable away from the saw blade.

Based on above, improvements are desired that increase the cutting capacity of table saws having sliding tables, and that also support the sliding table with sufficient rigidity so that the sawblade makes accurate cuts in the workpiece.

### SUMMARY

According to an exemplary embodiment of the disclosure, a table saw includes a base table, a sliding table, and a carriage. The base table includes a first guide rail and a second guide rail. The sliding table is configured for movement relative to the base table. The sliding table includes a third guide rail and a fourth guide rail. The carriage includes a support frame and at least four rollers configured for rotation relative to the support frame about corresponding axes of rotation. A first roller and a second roller of the at least four rollers are configured to receive the first guide rail and the third guide rail, and a third roller and a fourth roller of the at least four rollers are configured to receive the second guide rail and the fourth guide rail. The axes of rotation are substantially parallel. The carriage is configured for movement relative to the base table and the sliding table.

According to another exemplary embodiment of the disclosure, a table saw includes a base table, a sliding table, and a carriage. The base table includes a first guide rail and a second guide rail. The sliding table is configured for movement relative to the base table. The sliding table includes a third guide rail and a fourth guide rail. The carriage includes a first cross member, a second cross member operably connected to the first cross member, a first roller rotatably connected to a first end of the first cross member, a second roller rotatably connected to a first end of the second cross member, a third roller rotatably connected to a second end of the second cross member, and a fourth roller rotatably connected to a second end of the first cross member. The first roller and the second roller are configured to receive the first guide rail and the third guide rail. The third roller and the fourth roller are configured to receive the second guide rail and the fourth guide rail.

### BRIEF DESCRIPTION OF THE FIGURES

The above-described features and advantages, as well as others, should become more readily apparent to those of ordinary skill in the art by reference to the following detailed description and the accompanying figures in which:

FIG. 1 shows a portable table saw including a sliding table and a carriage (shown in phantom) for supporting the sliding table on a base table;

FIG. 2 is a top view showing a portion of the base table, the sliding table, and the carriage (shown in phantom);

FIG. 3 is a cross sectional view taken along line III-III of FIG. 2;

FIG. 4 shows the carriage of FIG. 1;

FIG. 5 shows a portion of the carriage of FIG. 1 including an elliptical-shaped opening in a cross member of the carriage; and

FIG. 6 shows a guide rail of the base table and a guide rail of the sliding table in engagement with a roller of the carriage.

### DETAILED DESCRIPTION

For the purpose of promoting an understanding of the principles of the disclosure, reference will now be made to the embodiments illustrated in the drawings and described in the following written specification. It is understood that no limitation to the scope of the disclosure is thereby intended. It is further understood that this disclosure includes any alterations and modifications to the illustrated embodiments and includes further applications of the principles of the disclosure as would normally occur to one skilled in the art to which this disclosure pertains.

Aspects of the disclosure are disclosed in the accompanying description. Alternate embodiments of the disclosure and their equivalents may be devised without parting from the spirit or scope of the disclosure. It should be noted that any discussion herein regarding “one embodiment”, “an embodiment”, “an exemplary embodiment”, and the like indicate that the embodiment described may include a particular feature, structure, or characteristic, and that such particular feature, structure, or characteristic may not necessarily be included in every embodiment. In addition, references to the foregoing do not necessarily comprise a reference to the same embodiment. Finally, irrespective of whether it is explicitly described, one of ordinary skill in the art would readily appreciate that each of the particular features, structures, or characteristics of the given embodiments may be utilized in connection or combination with those of any other embodiment discussed herein.

For the purposes of the disclosure, the phrase “A and/or B” means (A), (B), or (A and B). For the purposes of the disclosure, the phrase “A, B, and/or C” means (A), (B), (C), (A and B), (A and C), (B and C), or (A, B and C).

The terms “comprising,” “including,” “having,” and the like, as used with respect to embodiments of the disclosure, are synonymous.

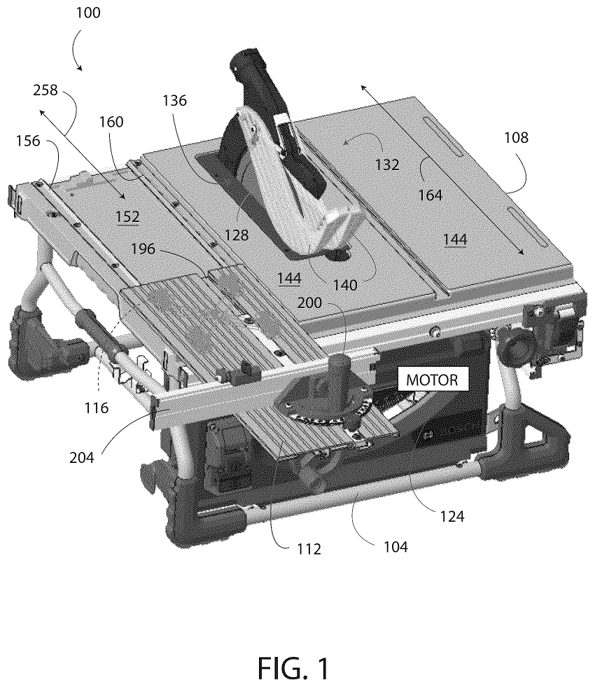

As shown in FIG. 1, a table saw 100 includes a housing 104 configured to support a base table 108 and a sliding table 112. The sliding table 112 is movable relative to the base table 108 using a carriage 116 that is located between the sliding table 112 and the base table 108. The carriage 116 is shown in phantom in FIG. 1. As disclosed herein, the carriage 116 enables the sliding table 112 to move relative to the base table 108 smoothly and with minimal side-to-side play. Moreover, the configuration of the base table 108, the sliding table 112, and the carriage 116 provides the table saw 100 with an increased cutting capacity as compared to other designs and configurations. Each element of the table saw 100 is described herein.

The housing 104 of the table saw 100 is configured for placement on the ground or a suitable stand. The housing 104 is formed from plastic or metal, and may be formed from any other like material. The housing 104 is lightweight to enable the table saw 100 to be easily carried by most people. The housing 104 is also referred to as a tube base.

With continued reference to FIG. 1, the table saw 100 further includes a motor 124, a sawblade 128, and a blade guard assembly 132. The motor 124 is located within the housing 104 and is configured to rotate the sawblade 128 for cutting workpieces. The motor 124 is typically powered by a mains power supply, but, in some embodiments, the motor 124 is powered by a removable and rechargeable battery pack (not shown). In FIG. 1, the motor 124 is shown in block diagram form. In an exemplary structural configuration, the motor 124 is located within the housing 104 below a recess portion 152 of the base table 108 on the left side of the sawblade 128.

The sawblade 128 is removable and replaceable by the user. The sawblade 128 is a circular sawblade. The user selects the type of sawblade 128 based on a material of the workpiece to be cut. The sawblade 128 extends above the base table 108 and the sliding table 112 through a corresponding opening 136 formed in the base table 108.

The blade guard assembly 132 at least partially surrounds the portion of the saw blade 128 that extends above the base table 108. The blade guard assembly 132 includes two guard bales 140 for shielding the sawblade 128.

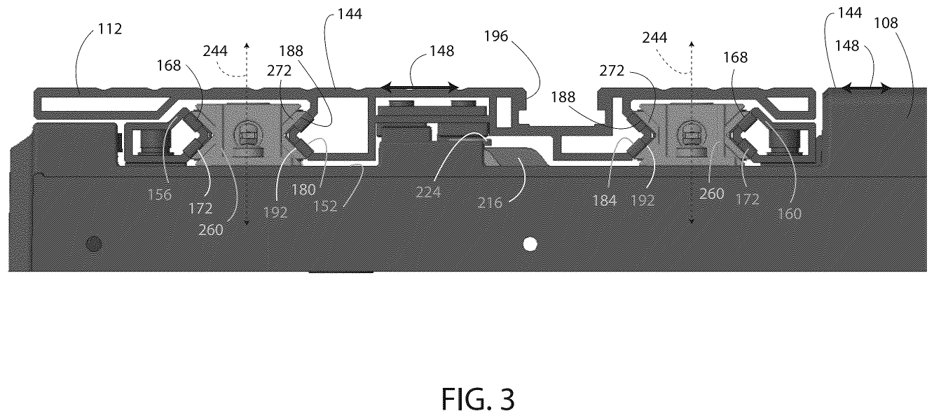

With continued reference to FIG. 1, the base table 108 is connected to the housing 104 and partially defines a flat workpiece support surface 144 and a corresponding workpiece support plane 148 (FIG. 3). The sliding table 112 also partially defines the workpiece support surface 144. Workpieces to be cut by the table saw 100 are positioned on the workpiece support surface 144 and are moved relative to the sawblade 128. The base table 108 defines a recess portion 152 that is positioned below the workpiece support surface 144.

The base table 108 includes a left outer guide rail 156 (i.e., a first guide rail) and a right outer guide rail 160 (i.e., a second guide rail). The outer guide rails 156, 160 are connected to the recess portion 152 of the base table 108 and are located below the workpiece support surface 144. The outer guide rails 156, 160 are linear and extend along a cutting axis 164 of the table saw 100.

As shown in FIG. 3, the outer guide rails 156, 160 are ninety degree (90°) square rails. The outer guide rails 156, 160 are oriented so that an upper guide surface 168, defined by the outer guide rails 156, 160, is rotated forty-five degrees (45°) from the workpiece support surface 144, and a lower guide surface 172, defined by the outer guide rails 156, 160, is rotated one hundred thirty-five degrees (135°) from the workpiece support surface 144. A corner of the outer guide rails 156, 160 is located between the upper guide surface 168 and the lower guide surface 172. In other embodiments, the angle between the upper guide surface 168 and the lower guide surface 172 is from thirty degrees (30°) to one hundred forty-five degrees (145°).

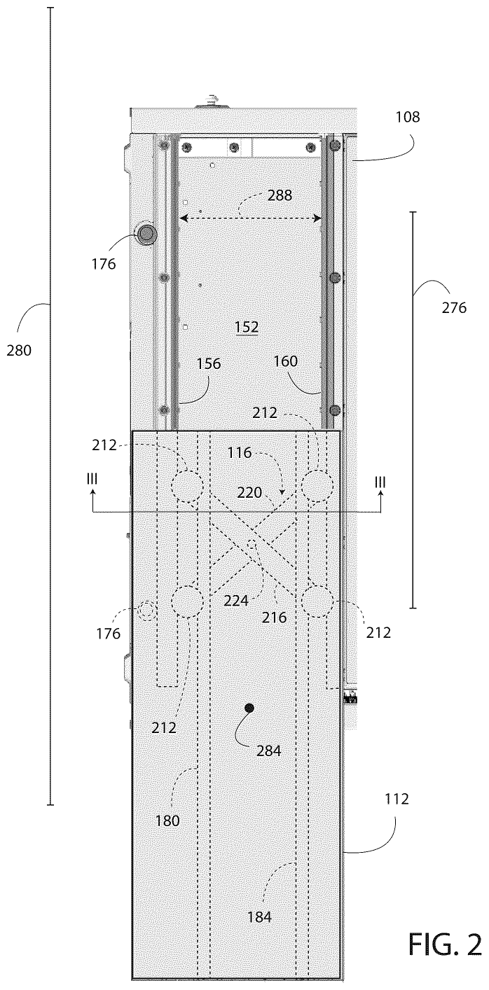

With reference to FIG. 2, the right outer guide rail 160 is fixedly connected to the base table 108, and the left outer guide rail 156 is movably connected to the base table 108. For example, the right outer guide rail 160 is connected to the base table 108 with screws, bolts, or other fasteners so that the right outer guide rail 160 cannot be moved relative to the base table 108. In other embodiments, the right outer guide rail 160 is integrally formed as a single piece with the base table 108. The left outer guide rail 156 is movable relative to the base table 108 and the right outer guide rail 160. That is, the left outer guide rail 156 is movable relative to the right outer guide rail 160, such that the outer guide rails 156, 160 can be configured in a parallel or a substantially parallel configuration. As used herein, substantially parallel is within five degrees (5°) of parallel. The outer guide rails 156, 160 are partially shown in phantom in FIG. 2, because a portion of the outer guide rails 156, 160 is obscured by the sliding table 112. The carriage 116 is also shown in phantom in FIG. 2, since it is completely obscured by the sliding table 112.

When the left outer guide rail 156 is positioned in a predetermined or desired position, the left outer guide rail 156 is locked, fastened, or clamped to the base table 108, such that the position of the left outer guide rail 156 becomes fixed relative to the base table 108 and the right outer guide rail 160. During usage of the table saw 100, the left outer guide rail 156 is in the locked configuration so that the outer guide rails 156, 160 do not move during cutting operations. In the exemplary embodiment of FIG. 2, the base table 108 includes two off-center cams 176 that are rotatable relative to the base table 108 in order to move the left outer guide rail 156 closer or farther from the right outer guide rail 160 and to change the angle of the left outer guide rail 156 relative to the right outer guide rail 160. A fastener extends through the off-center cam 176 that is tightened to fix the position of the off-center cam 176 and the left outer guide rail 156. Additional screws, bolts, or other fasteners extending through the left outer guide rail 156 and into the base table 108 are then tightened in order to fix the left outer guide rail 156 in the predetermined position. In other embodiments, different adjusting members are used to adjust the position of left outer guide rail 156, such as wedges, shims, and/or the like. Moreover, in other embodiments, the right outer guard rail 160 is also adjustable.

The adjustable left outer guide rail 156 aids in the manufacture and/or assembly of the table saw 100 and enables the table saw 100 to be mass producible without extremely precise machining. As described below, the adjustability of the left outer guide rail 156 also assists in taking up any slack between the carriage 116 and the sliding table 112.

With reference to FIGS. 1-3, the sliding table 112 is configured for movement relative to the base table 108. FIGS. 2 and 3 shows that the sliding table 112 includes a left inner guide rail 180 (i.e., a third guide rail) and a right inner guide rail 184 (i.e., a fourth guide rail). The inner guide rails 180, 184 are shown in phantom in FIG. 2. The inner guide rails 180, 184 have substantially the same configuration as the outer guide rails 156, 160 of the base table 108. In the illustrated example of FIG. 3, the inner guide rails 180, 184 are ninety degree (90°) square rails. The inner guide rails 180, 184 each define an upper guide surface 188 (FIG. 3) and a lower surface 192 (FIG. 3). The angle between the guide surfaces 188, 192 is the same as the angle between the guide surfaces 168, 172. The inner guide rails 180, 184 are linear and are parallel or substantially parallel to the outer guide rails 156, 160.

The inner guide rails 180, 184 extend from a bottom surface of the sliding table 112. In one embodiment, the inner guide rails 180, 184 are integrally formed with the sliding table 112. In another embodiment, the inner guide rails 180, 184 are separately formed and are connected to the bottom of the sliding table 112 using fasteners, screws, or the like. An upper surface of the sliding table 112 defines a portion of the workpiece support surface 144 and is coplanar with the workpiece piece support plane 148.

The sliding table 112 defines a longitudinal groove 196 configured to receive a miter gauge 200 (FIG. 1), for example. Moreover, as shown in FIG. 1, a cross cut support 204 is configured for connection to the sliding table 112. Any other cutting accessory may also be connected to the sliding table 112, as is used for the corresponding cutting operation.

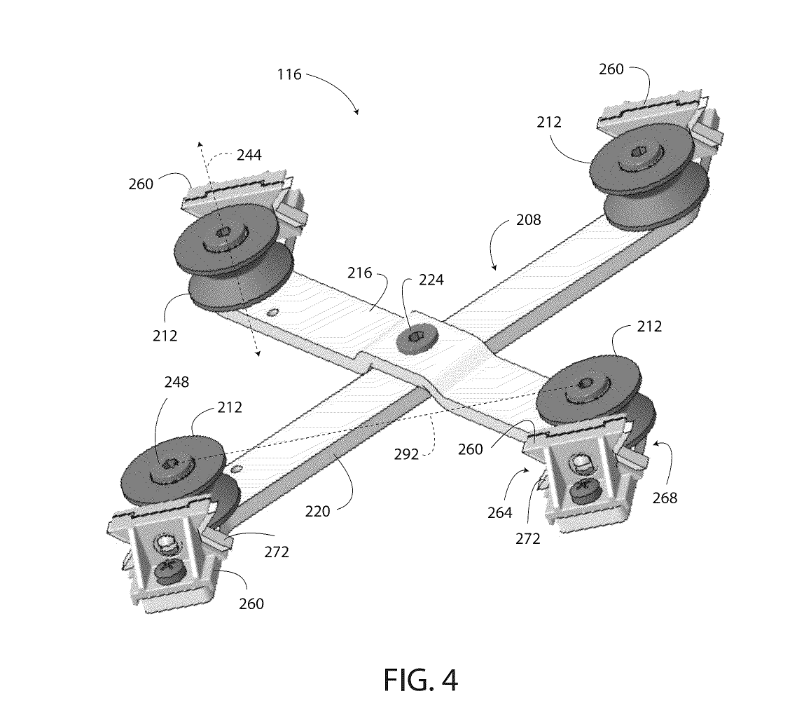

As shown in FIG. 4, the carriage 116, which is also referred to as floating carriage, a carriage assembly, and/or a cartridge, includes a support frame 208 and at least four rollers 212 operably connected to the support frame 208. The carriage 116 is configured for sliding movement along the outer guide rails 156, 160 and the inner guide rails 180, 184 to enable sliding movement of the sliding table 112 relative to the base table 108.

The X-shaped support frame 208 of the carriage 116 includes an upper cross member 216 (i.e., a first cross member) and a lower cross member 220 (i.e., a second cross member) that are configured to support the four rollers 212 and that are overlapped upon each other. The cross members 216, 220 are operably connected by a fastener 224. The upper cross member 216 is shaped or bent to define a recess for receiving the lower cross member 220.

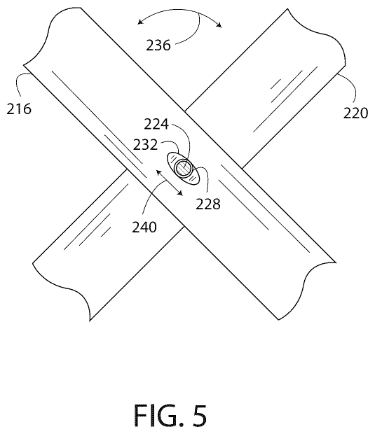

In one embodiment, as shown in FIG. 5, the lower cross member 220 defines a circular-shaped opening 228 to receive the fastener 224, and the upper cross member 216 defines an elliptical-shaded opening 232 (i.e., an oval-shaped opening) to receive the fastener 224. In FIG. 5, only a shaft portion of the fastener 224 is shown and the head of the fastener 224 is not shown so that both of the openings 228, 232 are visible. The fastener 224 includes a bolt and a nut, for example, that when tightened are configured to clamp the cross members 216. 220 together.

In one configuration, the fastener 224 connects the cross members 216, 220 with a tightness that configures the lower cross member 220 for movement relative to the upper cross member 216. That is, the fastener 224 prevents the cross members 216, 220 from becoming separated from each other, but enables the cross members 216, 220 to move relative to each other, in particular, when the sliding table 112 is moved relative to the base table 108. As shown in FIG. 5, a first pivot movement path 236 of the cross members 216, 220 occurs about an axis defined by the fastener 224. A second movement path 240 is along a major axis of the elliptical-shaped opening 232. Thus, the cross members 216, 220 are configured for rotational and translational movement relative to each other. In a typical configuration, an angle between cross members 216, 220 ranges from eighty degrees (80°) to one hundred degrees (100°). Nominally, the cross members 216, 220 are perpendicular or substantially perpendicular. Substantially perpendicular is within five degrees (5°) of perpendicular.

In other embodiments, both of the openings 228, 232 are circular-shaped and the cross members 216, 220 are configured only for rotational movement relative to each other about the pivot movement path 236. Moreover, in a further embodiment, both of the openings 228, 232 are elliptical-shaped, such that translation movement occurs along the major axes of both elliptical-shaped openings.

With reference again to FIG. 4, the four rollers 212 are configured for rotation relative to the support frame 208 about corresponding axes of rotation 244, one of which is identified. Specifically, each roller 212 is connected to the support frame 208 by an axle 248 that is threadingly received by a corresponding threaded opening in the cross member 216, 220. The axle 248 does not rotate relative to the cross members 216, 220. In some embodiments, a bearing (not shown) is located between the rollers 212 and the axle 248. The axles 248 parallel to each other and are perpendicular to the workpiece support plane 148. The rollers 212 rotate about the axles 248 and the axes of rotation 244. The axes of rotation 244 of the rollers 212 are parallel or substantially parallel to each other, and are perpendicular or substantially perpendicular to the workpiece support plane 148. The lower cross member 220 supports two of the rollers 212 (i.e., the first and the fourth rollers), and the upper cross member 216 supports the other two rollers 212 (i.e., the second and third rollers). Thus, each cross member 216, 220 support two of the rollers 212.

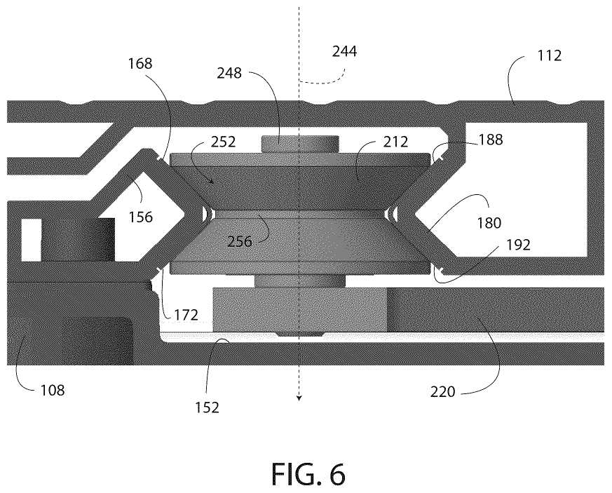

As shown in FIG. 6, the rollers 212 are configured as ninety degree (90°) V-rollers configured to receive the ninety degree square rails of the guide rails 156, 160, 180, 184. The angle of the V-rollers 212 corresponds and/or matches the angle of the guide rails 156, 160, 180, 184. Thus, the angle of the V-rollers 212 ranges from thirty degrees (30°) to one hundred forty-five degrees (145°). Each roller 212 defines a corresponding roller groove 252 and apex 256 in which the corners of the guide rails 156, 160, 180, 184 are positioned. The apexes 256 of the rollers 212 are coplanar.

FIG. 2 illustrates that two left rollers 212 (i.e., a first and a second roller) are configured to receive the left outer guide rail 156 of the base table 108 and the left inner guide rail 180 of the sliding table 112. FIG. 2 also illustrates that two right rollers 212 (i.e., a third and a fourth roller) are configured to receive the right outer guide rail 160 of the base table 108 and the right inner guide rail 184 of the sliding table 112. Thus, the rollers are wedged between corresponding guide rails 156, 160, 180, 184, and the cross configuration of the support frame 208 results in a robustly supported sliding table 112 that moves freely and easily and with very little side-to-side play along an axis of movement 258 (FIG. 1) that is parallel to the cutting axis 164.

With reference again to FIG. 4, the carriage 216 is configured to support four rail wipes 260. The rail wipes 260 or guide rail wipes are connected to a corresponding one of the cross members 216, 220. With respect to the axis of movement 258 of the sliding table 112 and the carriage 116, the two left rollers 212 are located between two left rail wipes 260, and the two right rollers 212 are located between two right rail wipes 260.

The rail wipes 260 are positioned against the guide rails 156, 160, 180, 184 and are configured to wipe dust and debris off the guide rails 156, 160, 180, 184 during movement of the sliding table 112 and the carriage 116. As shown in FIG. 4, the each rail wipe 260 defines a left notch 264 (i.e., a first notch) and a right notch 268 (i.e., a second notch). The notches 264, 268 are configured to receive a corresponding guide rail 156, 160, 180, 184. An angle of the notches 264, 268 corresponds and/or matches the angle of the guide rails 156, 160, 180, 184 and the V-rollers 212. In one embodiment, the notches 264, 268 are lined with a wiping element 272, provided as felt or another suitable material, such that as the wiping elements 272 move along the guide rails 156, 160, 180, 184 dust and debris is wiped off the guide rails 156, 160, 180, 184 without damaging or scratching the guide rails 156, 160, 180, 184. In the illustrated configuration each rail wipe 260 is configured to wipe two of the guide rails 156, 160, 180, 184 simultaneously during movement of the sliding table 112 and the carriage 116 relative to the base table 108.

The rail wipes 260 are an optional element of the carriage 116, and some embodiments of the carriage 116 do not include the rail wipes 260.

In operation, the table saw 100 is configured to provide smooth and accurate movement of the sliding table 112 relative to the base table 108 and the housing 104 of the table saw 100. With reference to FIG. 1, the sliding table 112 is movable along the movement axis 258. A workpiece (not shown) is placed on the sliding table 112, with the sliding table 112 in a start position (FIG. 1), and then the sliding table 112 is moved past the sawblade 128 in order to cut the workpiece. Next, the sliding table 112 is retracted to the start position to prepare for another cutting operation. As the operator moves the sliding table 112, the carriage 116 is moved between the guide rails 156, 160, 180, 184 relative to the base table 108.

Specifically, due to the above-described structural configuration, the carriage 116 is configured for movement relative to the base table 108 and the sliding table 112 during movement of the sliding table 112. That is, the carriage 116 is captured between the guide rails 180, 184 of the sliding table 112 and the guide rails 156, 160 of the base table 108, but is not fixedly attached to either of the sliding table 112 or the base table 108, which results in the carriage 116 being termed a “floating” carriage 116. As a result, when the sliding table 112 is moved towards the sawblade 128 to cut a workpiece, the carriage 116 also moves toward the sawblade 128, however, as described below, the carriage 116 and the sliding table 112 move different distances along the movement axis 258.

The floating configuration of the carriage 116 greatly increases the cutting capacity of the table saw 100 as compared to other configurations having sliding workpiece support surfaces. An exemplary cutting capacity of the table saw 100 is 400 mm and the cutting capacity of other embodiments ranges from 250 mm to 600 mm. Because the carriage 116 is floating, when the carriage 116 moves X distance, the sliding table 112 moves 2× distance (i.e., twice the distance of the carriage 116). FIG. 2 illustrates a range of movement 276 of the carriage 116 and a range of movement 280 of the sliding table 112. The range of movement 276 of the carriage 116 is measured from the fastener 224 in a fully retracted position (the bottom of the page in FIG. 2) to the fastener 224 in a fully extended position (the top of the page in FIG. 2). The range of movement 280 of the sliding table 112 is measured from a longitudinal center 284 of the sliding table 112 at the fully retracted position to the longitudinal center 284 at the fully extended position. As is shown, the range of movement 280 of the sliding table 112 is twice the length of the range of movement 276 of the carriage 116. The floating configuration of the carriage 116 provides this increased range of movement 280, which directly increases the cutting capacity of the table saw 100. The sliding table in FIG. 2 is moved toward the fully retracted position, but is not in the fully retracted position. That is, in FIG. 2 the sliding table 112 and the carriage 116 can still be moved farther in the downward direction, as shown by comparing the position of the fastener 224 and the center 284 to the respective ranges 276, 280.

During movement of the sliding table 112 and the carriage 116, the support frame 208 of the carriage 116 compensates for dimensional differences of the guide rails 156, 160, 180, 184, the base table 108, the sliding table 112, and other parts of the table saw 100. In particular, the fastener 224, which is located in the elliptical-shaped opening 232, loosely connects the cross members 216, 220 such that the cross members 216, 220 can pivot rotationally and move translationally during the sliding of the carriage 116 on the guide rails 156, 160, 180, 184. The movement of the cross members 216, 220 self-aligns the carriage 116 and enables the guide rails 156, 160, 180, 184 to be positioned and structured with less precision. That is, the guide rails 156, 160, 180, 184 are formed as parallel linear rails, but machine tolerances may result in variations in a horizontal distance 288 (FIG. 2) between the guide rails 156, 160, 180, 184. By enabling the support frame 208 to flex and pivot, the carriage 116 compensates for these variations, and the sliding table 112 is smoothly and accurately moved relative to the base table 108 and the sawblade 128. The compensation occurs as a result of a change in horizontal distance 292 (FIG. 4) between the rollers 212, as permitted by the fastening member 224 and the elliptical shaped opening 232. Stated differently, the compensation occurs as a result of a changing angle between the cross members 216, 220, as permitted by the fastening member 224 and the elliptical shaped opening 232.

The square rails forming the guide rails 156, 160, 180, 184 and the corresponding V-shaped rollers 212 provide support against vertical loading on the sliding table 112. By utilizing square rails having the wide support surfaces 168, 172, 188, 192, additional contact area is provided as compared to other configurations having round rails.

In an exemplary embodiment, the guide rails 156, 160, 180, 184 are formed from aluminum and the V-shaped rollers 212 are formed from plastic. For an even more durable configuration, the guide rails 156, 160, 180, 184 are formed from hardened steel or hardened steel plates, and the V-shaped rollers 212 are formed from steel. The sliding table 112 is formed from aluminum and, in one embodiment, is formed from extruded aluminum.

While the disclosure has been illustrated and described in detail in the drawings and foregoing description, the same should be considered as illustrative and not restrictive in character. It is understood that only the preferred embodiments have been presented and that all changes, modifications and further applications that come within the spirit of the disclosure are desired to be protected.

What is claimed is:

1. A table saw, comprising:
a base table including a first guide rail and a second guide rail;
a sliding table configured for movement relative to the base table, the sliding table including a third guide rail and a fourth guide rail;
a carriage including a support frame and at least four rollers configured for rotation relative to the support frame about corresponding axes of rotation,
wherein a first roller and a second roller of the at least four rollers are configured to receive the first guide rail and the third guide rail, and a third roller and a fourth roller of the at least four rollers are configured to receive the second guide rail and the fourth guide rail,
wherein the axes of rotation are substantially parallel, and
wherein the carriage is configured for movement relative to the base and the sliding table.

2. The table saw of claim 1, wherein:
the carriage includes a first cross member and a second cross member,
the first cross member rotatably supports the first roller and the fourth roller, and
the second cross member rotatably supports the second roller and the third roller.

3. The table saw of claim 2, wherein the first cross member is configured for movement relative to the second cross member.

4. The table saw of claim 3, further comprising:
a fastening member extending through an elliptical-shaped opening in the first cross member and a circular-shaped opening in the second cross member in order to operably connect the first cross member to the second cross member.

5. The table saw of claim 1, wherein:
the first guide rail, the second guide rail, the third guide rail, and the fourth guide rail are ninety degree square rails, and
the at least four rollers are ninety degree V-rollers configured to receive the ninety degree square rails.

6. The table saw of claim 1, wherein:
each roller of the at least four roller defines a roller groove defining an apex, and
each apex of the at least four rollers is coplanar.

7. The table saw of claim 1, further comprising:
at least one rail wipe operably connected to the support frame and positioned against at least one of the first guide rail, the second guide rail, the third guide rail, and the fourth guide rail.

8. The table saw of claim 7, wherein:
the at least one rail wipe includes four of the rail wipes,
the carriage includes a first cross member and a second cross member,
the first cross member rotatably supports the first roller and the fourth roller,
the second cross member rotatably supports the second roller and the third roller,
the first roller and the fourth roller are located between a first rail wipe and a second rail wipe of the four rail wipes along an axis of movement of the sliding table, and
the second roller and the third roller are located between a third rail wipe and a fourth rail wipe of the four rail wipes along the axis of movement of the sliding table.

9. The table saw of claim 7, wherein:
the at least one rail wipe includes a first notch configured to receive the first guide rail connected to the base table and an opposite second notch configured to receive the third guide rail of the sliding table, such that the at least one rail wipe is configured to wipe the first guide rail and the third guide rail simultaneously when the sliding table is moved relative to the base table.

10. The table saw of claim 1, wherein:
the first guide rail is fixed in position relative to the base table,
the second guide rail is movable relative to the base table and the first guide rail.

11. The table saw of claim 10, further comprising:
an off-center cam operably connected to the base table and configured to rotate in order to move the second guide rail.

12. A table saw, comprising:
a base table including a first guide rail and a second guide rail;
a sliding table configured for movement relative to the base table, the sliding table including a third guide rail and a fourth guide rail;
a carriage including a first cross member, a second cross member operably connected to the first cross member, a first roller rotatably connected to a first end of the first cross member, a second roller rotatably connected to a first end of the second cross member, a third roller rotatably connected to a second end of the second cross member, and a fourth roller rotatably connected to a second end of the first cross member,
wherein the first roller and the second roller are configured to receive the first guide rail and the third guide rail,
wherein the third roller and the fourth roller are configured to receive the second guide rail and the fourth guide rail.

13. The table saw of claim 12, wherein the first cross member is configured for movement relative to the second cross member.

14. The table saw of claim 13, further comprising:
a fastening member extending through an elliptical-shaped opening in the first cross member and a circular-shaped opening in the second cross member in order to operably connect the first cross member to the second cross member.

15. The table saw of claim 12, wherein:
the first roller, the second roller, the third roller, and the fourth roller each define a corresponding axis of rotation,
the axes of rotation are substantially parallel,
the sliding table defines a workpiece support plane, and
the axes of rotation are substantially perpendicular to the workpiece support plane.

16. The table saw of claim 12, wherein the carriage is configured for movement relative to the base table and the sliding table.

17. The table saw of claim 12, wherein:
the first guide rail, the second guide rail, the third guide rail, and the fourth guide rail are ninety degree square rails, and
the first roller, the second roller, the third roller, and the fourth roller are ninety degree V-rollers configured to receive the ninety degree square rails.

18. The table saw of claim 12, further comprising:
a rail wipe operably connected to the first end of the first cross member, the rail wipe defining a first notch configured to receive the first guide rail of the base table and an opposite second notch configured to receive the third guide rail of the sliding table.

19. The table saw of claim 18, further comprising:
a first wiping element mounted in the first notch; and
a second wiping element mounted in the second notch,
wherein when the sliding table is moved relative to the base table (i) the first wiping element is configured to wipe the first guide rail, and (ii) the second wiping element is configured to wipe the third guide rail.

20. The table saw of claim 12, wherein:
the first roller, the second roller, the third roller, and the fourth roller each define a roller groove defining an apex, and
each apex is coplanar.
